(19) United States
(12) Patent Application Publication
(10) Pub. No.: US 2026/0198480 A1
(43) Pub. Date: Jul. 16, 2026

(54) ELECTRIC CORD PET-BITING DETERRENT SYSTEM

(71) Applicant: John Wayne THOMAS, Midland, NC (US)

(72) Inventor: John Wayne THOMAS, Midland, NC (US)

(21) Appl. No.: 19/542,208

(22) Filed: Feb. 17, 2026

Related U.S. Application Data
(63) Continuation-in-part of application No. 17/689,055, filed on Mar. 8, 2022, now abandoned.

(51) Int. Cl. A01M 29/24

(52) U.S. Cl. CPC A01M 29/24

(57) ABSTRACT

An electrical cord pet-biting deterrent system includes a plug structure and a cable structure connected to and extending from the plug structure. The plug structure including a housing, a circuit board, and a power source. The housing having a pair of non-conductive prongs extending from a surface thereof which are configured to insert into a wall socket without drawing electrical power from the wall socket. The circuit board disposed within the housing and including a movement detector, a microcontroller, and a transistor. The cable structure including a central cord and a plurality of external conductive wires wrapped helically around the central cord. The movement detector being configured to detect mechanical vibrations of the cable structure and send a signal to the microcontroller upon detection of such mechanical vibrations. The microcontroller configured to actuate the transistor to electrically couple the power source to at least one of the plurality of external conductive wires for a predetermined duration to deliver an electrical stimulus through the external conductive wires.

### CROSS REFERENCES AND PRIORITIES

This Application claims priority from U.S. application Ser. No. 17/689,055 filed on 8 Mar. 2022, the teachings of which are incorporated by reference herein in their entirety.

### BACKGROUND

Pets, including but not limited to domestic dogs, cats, rabbits, and other companion animals are known to frequently chew on a variety of household objects including furniture, door frames, footwear, and electrical cords. Electrical cords pose a particularly high risk when chewed upon by pets. Electrical cords are commonly used to supply power to household electronic devices and appliances. When chewed, underlying conductive wires capable of delivering an electrical shock to a pet may be exposed. Electrical cords typically include a polymeric outer insulation surrounding one or more conductive wires. Chewing through the insulation may expose energized conductors capable of causing severe injury or electrocution. In addition to risks posed to the animal, damage to electrical cords may create secondary hazards such as electrical arcing, short circuits, and fire, and may result in recurring replacement costs and inconvenience for pet owners.

Existing approaches to preventing pets from chewing electrical cords include supervision, behavioral redirection with toys, deterrent sprays, and the use of protective cord covers. Continuous supervision is often impractical, and deterrent sprays may evaporate, degrade, or prove ineffective for certain animals, requiring frequent reapplication and ongoing expense. Protective cord covers may be costly and/or impractical to deploy throughout a home and are commonly fabricated from materials that may still be chewed through by pets.

The need exists, therefore, for deterrent training aids to deter animals from damaging an electrically conductive power cord.

### SUMMARY

Described herein is an electrical cord pet-biting deterrent system. The system includes a plug structure and a cable structure. The plug structure having a housing, a circuit board, and a power source. The cable structure connected to and extending from the plug structure and including a central cord and a plurality of external conductive wires. The housing including a pair of non-conductive prongs extending from a surface thereof which are configured to insert into a wall socket without drawing electrical power from the wall socket. The circuit board being disposed within the housing and including a movement detector, a microcontroller, and a transistor. The plurality of external conductive wires being wrapped helically around the central cord with each external conductive wire electrically connected to the power source. The transistor being electrically coupled between the power source and at least one of the plurality of external conductive wires. The movement detector being configured to detect mechanical vibrations of the cable structure. The microcontroller being configured to receive a signal from the movement detector upon detection of a mechanical vibration and to actuate the transistor to electrically couple the power source to at least one of the plurality of external conductive wires for a predetermined duration. An electrical stimulus being delivered through the plurality of external conductive wires when an electrically conductive path is formed between at least two of the plurality of external conductive wires by contact with an animal.

In some embodiments, the cable structure may be permanently connected to the plug structure. In other embodiments, the cable structure may be removably connected to the plug structure.

In certain embodiments, the power source may be a battery. In some such embodiments, the battery may include at least one battery or battery pack configured to provide a battery voltage in a range of between 3 V and 30 V.

In some embodiments, the central cord may include a material having a modulus of elasticity in a range of between 500 MPa and 3,000 MPa.

In certain embodiments, the plurality of external conductive wires may include at least a first external conductive wire and a second external conductive wire. In some embodiments, each external conductive wire of the plurality of external conductive wires may be made of a material selected from the group consisting of copper, a copper alloy, stainless steel, steel, a carbon-based conductive material, a conductive polymer, a conductive elastomer, a conductive fluorocarbon material, and combinations thereof.

In some embodiments, the timed discharge of electricity may be configured to have a voltage in a range of between 3.0 V and 50 V. In certain embodiments, the timed discharge of electricity may be configured to have a current in a range of between 1.0 mA and 35 mA. In some embodiments, the timed discharge of electricity may be configured to occur for a length of time in a range of between 0.001 seconds and 10 seconds.

In certain embodiments, the housing may further include an on-off switch operably connected between the power source and the circuit board. When present, the on-off switch may be configured to allow a user to open and close a circuit between the power source and the circuit board.

In some embodiments, the housing may further include a power adjustment mechanism operably connected between the power source, the circuit board, and the plurality of external conductive wires. When present, the power adjustment mechanism may be configured to allow a user to select a voltage and/or a current for the timed discharge of electricity.

In certain embodiments, the housing may further include a time adjustment mechanism operably connected to the circuit board. When present, the time adjustment mechanism may be configured to allow a user to select a duration of the timed discharge of electricity delivered through the plurality of external conductive wires.

### BRIEF DESCRIPTION OF FIGURES

FIG. 1 is a perspective view of an exemplary embodiment of an electrical cord pet-biting deterrent system.

FIG. 2 is a side view of an exemplary embodiment of an electrical cord pet-biting deterrent system.

FIG. 3 is a top cross section view of an exemplary embodiment of an electrical cord pet-biting deterrent system.

FIG. 4 is a rear view of an exemplary embodiment of a plug structure for an electrical cord pet-biting deterrent system.

FIG. 5 is a cross section view of an exemplary embodiment of a cable structure for an electrical cord pet-biting deterrent system.

FIG. 6 is a perspective view of an exemplary embodiment of an electrical cord pet-biting deterrent system in use.

FIG. 7 is a schematic view of an exemplary embodiment of a wiring system for an electrical cord pet-biting deterrent system.

### DETAILED DESCRIPTION

Disclosed herein is an electrical cord pet-biting deterrent system. As described herein, the following numbers refer to the following structures as noted in the Figures.
10 refers to an electrical cord pet-biting deterrent system.
100 refers to a plug structure.
110 refers to a housing.
111 refers to a non-conductive prong.
120 refers to a circuit board.
121 refers to a movement detector.
122 refers to a microcontroller.
123 refers to a transistor.
130 refers to a power source.
140 refers to an on-off switch.
200 refers to a cable structure.
210 refers to a central cord.
220 refers to an external conductive wire.
221 refers to a first external conductive wire.
222 refers to a second external conductive wire.

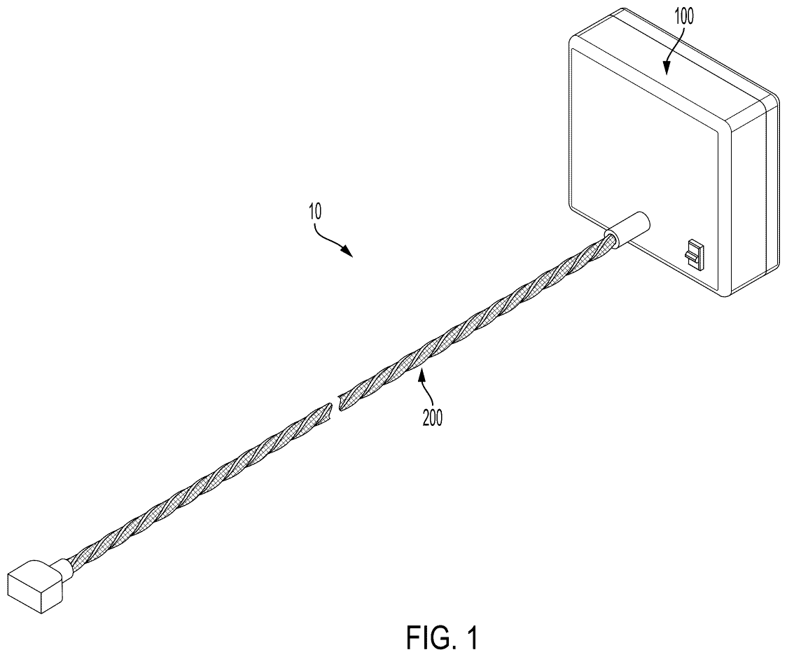

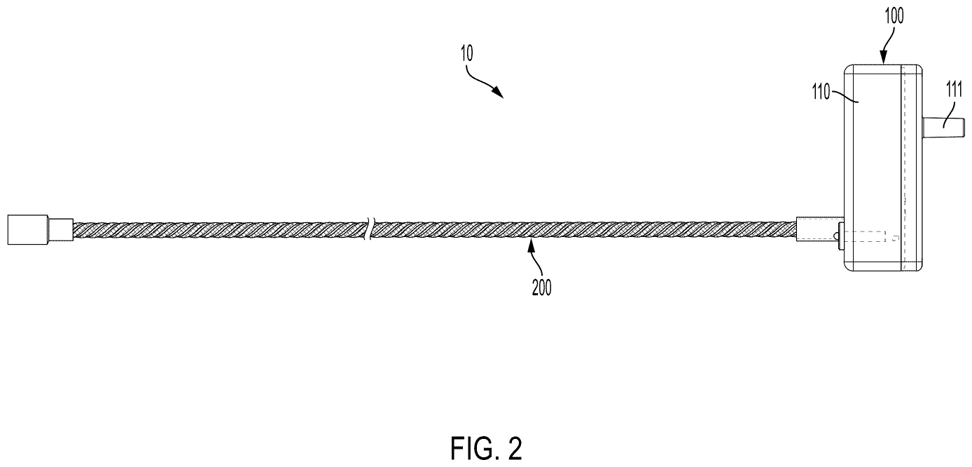

FIG. 1 illustrates an exemplary embodiment of an electrical cord pet-biting deterrent system (10) with FIG. 2 illustrating a side view of the exemplary embodiment of an electrical cord pet-biting deterrent system. As illustrated in FIGS. 1 and 2, the electrical cord pet-biting deterrent system may include a plug structure (100) and a cable structure (200).

The plug structure (100) for the electrical cord pet-biting deterrent system (10) may include a housing (110) having a pair of non-conductive prongs (111) extending from a surface thereof as illustrated in FIGS. 1 through 4. By non-conductive it is meant that the material resists the flow of current from a source of electricity. Examples of such non-conductive materials-which may be referred to as insulators-include polymer materials such as high density polyethylene (HDPE), polyvinyl chloride (PVC), nylons, and the like. The housing, in conjunction with the non-conductive prongs, may be intended to simulate the appearance of a power plug or charging cube such as those found in many electrical charging cords.

As illustrated in FIGS. 1 and 2, the cable structure (200) may be connected to and extend from the plug structure. The cable structure may be intended to simulate the appearance of a power cable such as those found in many electrical charging cords. In some embodiments, the cable structure may be permanently connected to the plug structure (100). In other embodiments the cable structure may be removably connected to the plug structure.

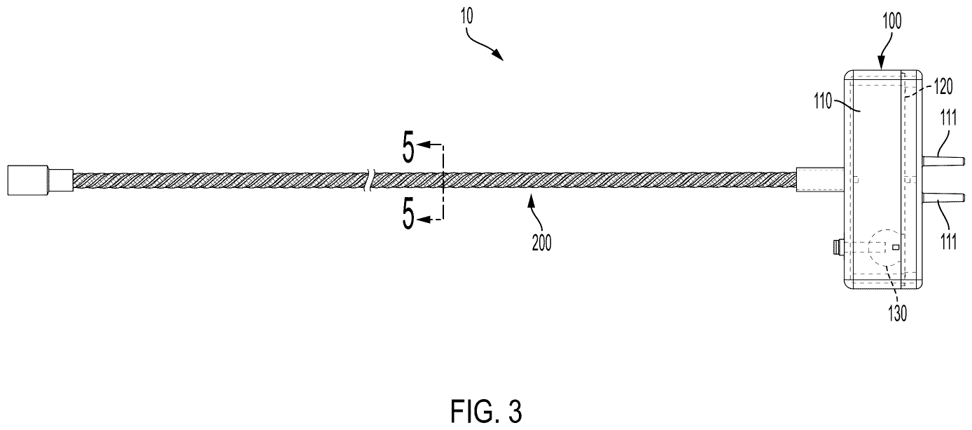

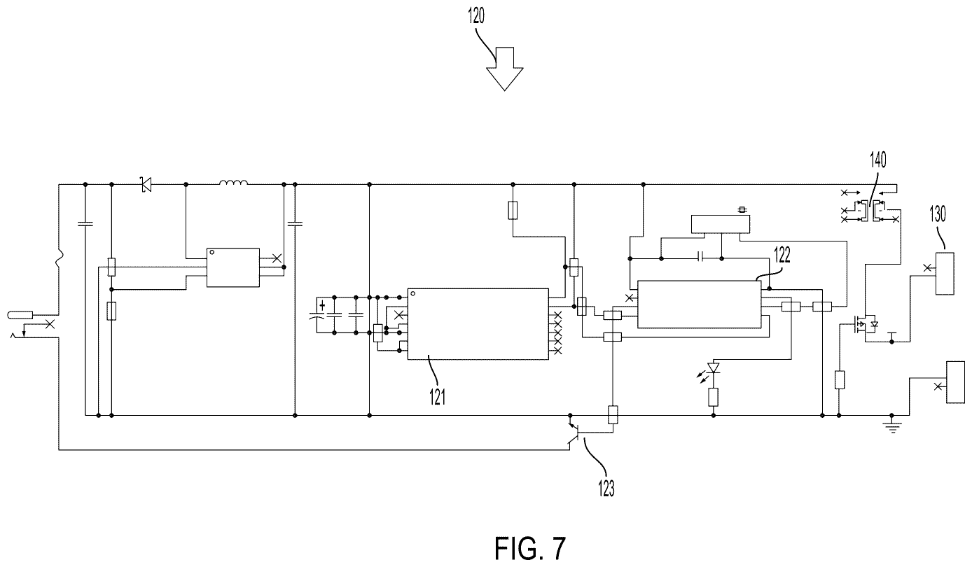

FIG. 3 illustrates a partial cross section view of an exemplary embodiment of an electrical cord pet-biting deterrent system (10) viewed from the top of the plug structure (100). As further illustrated in FIG. 3, the plug structure may include a circuit board (120) and a power source (130). Additional features of the circuit board are illustrated in FIG. 7 and described herein. Preferably, the circuit board will include a movement detector (121) such as a 3-Axis ADXL345 accelerometer available from Analog Devices Inc. of Wilmington, Massachusetts, U.S.A. The circuit board also preferably includes a microcontroller (122) such as an ATtiny412 microcontroller available from Microchip Technology Inc. of Chandler, Arizona, U.S.A. Preferably, the circuit board also includes a transistor (123) such as an MMBT4401 available from Diodes Incorporated of Plano, Texas, U.S.A.

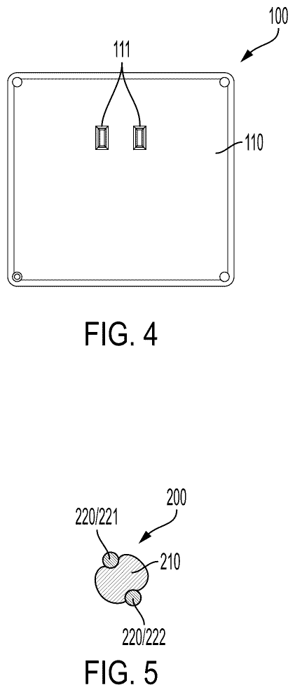

FIG. 4 illustrates a rear view of an exemplary embodiment of housing (110) for an exemplary embodiment of an electrical cord pet-biting deterrent system (10) including the pair of non-conductive prongs (111). While the pair of non-conductive prongs may be configured to insert into a conventional wall electric outlet, the electrical cord pet-biting deterrent system will preferably be configured to operate without receiving electricity from such a wall electric outlet. That is to say that the electrical cord pet-biting deterrent system may be configured to operate via a source of electricity-such as the power source ((130) as shown in FIG. 3)—which is separate and independent from an AC or DC electrical outlet.

FIG. 5 illustrates a cross section view of an exemplary embodiment of a cable structure (200) for an electrical cord pet-biting deterrent system (10). As shown in FIG. 5, the cable structure may include a central cord (210) and a plurality of external conductive wires (220). The external conductive wires may be wrapped helically around the central cord with each external conductive wire electrically connected to the circuit board ((120) as shown in FIG. 3). Preferably, at least a portion of one or both of the external conductive wires will extend past the outer surface of the central cord while a second portion of at least one of the external conductive wires may be embedded into the central cord as shown in FIG. 5.

Preferably, the central cord (210) will be fabricated of a flexible material which simulates the flexibility of a power cable for an electrical charging cord. Flexibility of the material from which the central cord may be manufactured may be expressed as a modulus of elasticity which may be in a range selected from the group consisting of between 500 MPa and 3,000 MPa, between 500 MPa and 2,500 MPa, between 500 MPa and 2,000 MPa, between 500 MPa and 1,500 MPa, between 500 MPa and 1,000 MPa, between 1,000 MPa and 3,000 MPa, between 1,000 MPa and 2,500 MPa, between 1,000 MPa and 2,000 MPa, between 1,000 MPa and 1,500 MPa, between 1,500 MPa and 3,000 MPa, between 1,500 MPa and 2,500 MPa, between 1,500 MPa and 2,000 MPa, between 2,000 MPa and 3,000 MPa, between 2,000 MPa and 2,500 MPa, and between 2,500 MPa and 3,000 MPa. Examples of such materials from which the central cord may be manufactured include a silicone material, a thermoplastic elastomer (TPE) or a polymer material such as polyethylene (PE), high-density polyethylene (HDPE), a nylon or polyvinyl chloride (PVC).

In preferred embodiments, the plurality of external conductive wires (220) may include at least two external conductive wires referred to as a first external conductive wire (221) and a second external conductive wire (222). Each external conductive wire of the plurality of external conductive wires may be manufactured of an electrically conductive material selected from the group consisting of copper, a copper alloy, stainless steel, steel, a carbon-based conductive material, a conductive polymer, a conductive elastomer, a conductive fluorocarbon material, and combinations thereof.

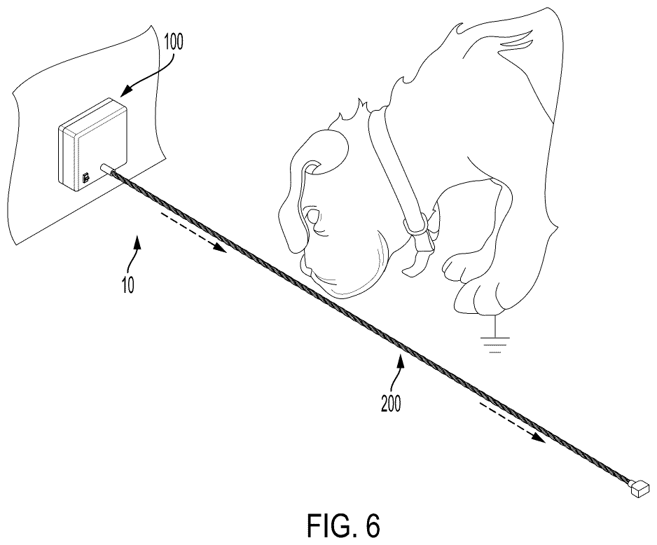

FIG. 6 illustrates a perspective view of an exemplary embodiment of an electrical cord pet-biting deterrent system (10) in use. While FIG. 6 illustrates connection to a standard wall socket, use of the system is not so limited. When a pet—including, but not limited to, a dog (shown in FIG. 6), cat, rabbit, or other animal—attempts to move the cable structure (200)—such as by picking up the cable structure (200) the movement detector ((121) as shown in FIG. 7) senses the mechanical vibrations and generates movement signals. The microcontroller (122) monitors the movement detector and, upon detecting a qualifying movement signal, actuates the transistor (123) to complete an electrical connection between the power source (130) and the plurality of external conductive wires (220). In some embodiments, the microcontroller may deliver a timed or pulse-width-modulated (PWM) corrective stimulus through the plurality of external conductive wires. While FIG. 6 illustrates the electrical cord pet-biting deterrent system connected to a standard wall socket, use of the electrical cord pet-biting deterrent system is not so limited. For example, in some embodiments, the cable structure of the electrical cord pet-biting deterrent system may be wrapped partially or fully around a shoe to simulate a shoelace in order to deter biting or chewing of the shoe/shoelace by the companion animal.

The timed discharge of electricity may be measured by voltage, current, and/or length of time. Voltage for the timed discharge of electricity may be in a range selected from the group consisting of between 3.0 V and 50 V, between 3.0 V and 40 V, between 3.0 V and 30 V, between 3.0 V and 20 V, between 3.0 V and 10 V, between 5.0 V and 50 V, between 5.0 V and 40 V, between 5.0 V and 30 V, between 5.0 V and 20 V, between 5.0 V and 10 V, between 10 V and 50 V, between 10 V and 40 V, between 10 V and 30 V, and between 10 V and 20 V. Current for the timed discharge of electricity may be in a range selected from the group consisting of between 1.0 mA and 35 mA, between 1.0 mA and 25 mA, between 1.0 mA and 15 mA, between 1.0 mA and 5.0 mA, between 5.0 mA and 35 mA, between 5.0 mA and 25 mA, between 5.0 mA and 15 mA, between 15 mA and 35 mA, between 15 mA and 25 mA, and between 25 mA and 35 mA. Time for the timed discharge of electricity may be in a range selected from the group consisting of between 0.001 seconds and 10 seconds, between 0.001 seconds and 5 seconds, between 0.001 seconds and 2.5 seconds, between 0.001 seconds and 1 second, between 0.1 seconds and 10 seconds, between 0.1 seconds and 5 seconds, between 0.1 seconds and 2.5 seconds, between 0.1 seconds and 1 second, between 1 second and 10 seconds, between 1 second and 5 seconds, and between 1 second and 2.5 seconds.

The timed discharge of electricity may be felt by the companion animal causing the companion animal to release the cable structure. Over time, the companion animal learns to associate biting or chewing the cable structure with the aversive stimuli associated with the timed discharge of electricity such that the companion animal no longer attempts to bite or chew on the cable structure. As the plug structure (100) and the cable structure (200) may be configured to simulate the appearance of an actual electrical charging cord, the companion animal will become less likely to attempt to bite or chew on an actual electrical charging cord which may be plugged into an AC or DC electrical outlet that would provide a higher voltage/current with an uncontrolled discharge of electricity that could seriously injure or kill the companion animal.

FIG. 7 illustrates a schematic for an exemplary embodiment of a circuit board (120) and wiring system for an electrical cord pet-biting deterrent system ((10) as illustrated in FIG. 3). Preferably, the circuit board will be located within an interior of the housing ((110) as shown in FIG. 3). As illustrated in FIG. 7, the circuit board may include a movement detector (121) of the type described herein. The circuit board may be electrically connected to the power source (130) such that the movement detector receives an operable supply of electricity-in the form of AC current or DC current from the power source. Preferably, the power source will be a battery such as a common 12 volt battery; one or more AA or AAA cell batteries, or a rechargeable battery pack, providing operating voltages of up to 30 V. In some embodiments, the device may include a housing containing a power source, a circuit board, and an on-off switch (140). The circuit board may include one or more electronic components such as a movement detector, a microcontroller, and a transistor. When the on-off switch is in an on position, a circuit is closed electrically connecting the power source to the circuit board. In this state, electrical power is made available to the circuit board, enabling the movement detector and associated control components to operate. When the on-off switch is in an off position, the switch electrically disconnects the power source from the circuit board thereby opening the electrical circuit. In this state, electrical power is not supplied to the circuit board, and the movement detector and associated components are inactive. Accordingly, the on-off switch may selectively control the availability of electrical power to the circuit board and the operation of the electronic components contained therein.

While not considered essential, the pet-biting deterrent system may also include a power adjustment mechanism which may be integrated into the housing. When present, the power adjustment mechanism may be operably connected between the power source, the circuit board, and the plurality of external conductive wires. The power adjustment mechanism—which may be in the form of an electric dial, a slider, or a plurality of capacitive buttons—allows a user to select a voltage and/or current level for the timed discharge of electricity.

FIG. 7 further illustrates an optional time adjustment mechanism which may also be integrated into the housing. When present, the time adjustment mechanism may be operably connected between the power source, the circuit board and the plurality of external conductive wires. The time adjustment mechanism—which may be in the form of an electric dial, a slider, or a plurality of capacitive buttons—allows a user to select a length of time for the timed discharge of electricity.

Embodiments of an electrical cord pet-biting deterrent system described herein represent an improvement over prior art solutions. The electrical cord pet-biting deterrent system may be left within reach of a companion animal—such as a dog—without the need for constant supervision. In the event that the companion animal chooses to chew on the electrical cord pet-biting deterrent system, a controlled electrical stimulus may be provided to the companion animal at appropriate (and optionally adjustable) voltage and current levels which do not risk serious injury or death to the companion animal. Doing so provides an aversive stimulus that is thought to deter companion animals from chewing on devices—such as live electrical power cables—that resemble the electrical cord pet-biting deterrent system in the future.

While the electrical cord pet-biting deterrent system has been described as having one or more exemplary designs, the present system may be further modified within the spirit and scope of this disclosure. This application is therefore intended to cover any variations, uses, or adaptations of the electrical cord pet-biting deterrent system using their general principles.

What is claimed is:

1. An electrical cord pet-biting deterrent system (10) comprising:
a plug structure (100) comprising:
a housing (110) having a pair of non-conductive prongs (111) extending from a surface thereof, said non-conductive prongs configured to insert into a wall socket without drawing electrical power from the wall socket;
a circuit board (120) disposed within the housing, said circuit board comprising a movement detector (121), a microcontroller (122), and a transistor (123); and
a power source (130); and
a cable structure (200) connected to and extending from the plug structure, said cable structure comprising:
a central cord (210); and
a plurality of external conductive wires (220) wrapped helically around the central cord with each external conductive wire electrically connected to the power source; and
wherein the transistor is electrically coupled between the power source and at least one of the plurality of external conductive wires, the movement detector is configured to detect mechanical vibrations of the cable structure, the microcontroller is configured to receive a signal from the movement detector upon detection of a mechanical vibration, the microcontroller is configured to actuate the transistor to electrically couple the power source to at least one of the plurality of external conductive wires for a predetermined duration, and wherein an electrical stimulus is delivered through the plurality of external conductive wires when an electrically conductive path is formed between at least two of the plurality of external conductive wires by contact with an animal.

2. The electrical cord pet-biting deterrent system of claim 1, wherein the cable structure is permanently connected to the plug structure.

3. The electrical cord pet-biting deterrent system of claim 1, wherein the cable structure is removably connected to the plug structure.

4. The electrical cord pet-biting deterrent system of claim 1, wherein the power source is a battery.

5. The electrical cord pet-biting deterrent system of claim 1, wherein the central cord comprises a material having a modulus of elasticity in a range of between 500 MPa and 3,000 MPa.

6. The electrical cord pet-biting deterrent system of claim 1, wherein the plurality of external conductive wires comprises at least a first external conductive wire (221) and a second external conductive wire (222).

7. The electrical cord pet-biting deterrent system of claim 1, wherein each external conductive wire of the plurality of external conductive wires is made of a material selected from the group consisting of copper, a copper alloy, stainless steel, steel, a carbon-based conductive material, a conductive polymer, a conductive elastomer, a conductive fluorocarbon material, and combinations thereof.

8. The electrical cord pet-biting deterrent system of claim 1, wherein the timed discharge of electricity is configured to have a voltage in a range of between 3.0 V and 50 V.

9. The electrical cord pet-biting deterrent system of claim 1, wherein the timed discharge of electricity is configured to have a current in a range of between 1.0 mA and 35 mA.

10. The electrical cord pet-biting deterrent system of claim 1, wherein the timed discharge of electricity is configured to occur for a length of time in a range of between 0.001 seconds and 10 seconds.

11. The electrical cord pet-biting deterrent system of claim 1, wherein the housing further comprises an on-off switch (140) operably connected between the power source and the circuit board and configured to allow a user to open and close a circuit between the power source and the circuit board.

12. The electrical cord pet-biting deterrent system of claim 1, wherein the housing further comprises a power adjustment mechanism operably connected between the power source, the circuit board, and the plurality of external conductive wires and configured to allow a user to select a voltage and/or a current for the timed discharge of electricity.

13. The electrical cord pet-biting deterrent system of claim 1, wherein the housing further comprises a time adjustment mechanism operably connected to the circuit board and configured to allow a user to select a duration of the timed discharge of electricity delivered through the plurality of external conductive wires.

14. The electrical cord pet-biting deterrent system of claim 4, wherein the battery comprises at least one battery or a battery pack configured to provide a battery voltage in a range of between 3 V and 30 V.

15. The electrical cord pet-biting deterrent system of claim 6, wherein the first external conductive wire and the second external conductive wire are each independently made of a material selected from the group consisting of copper, a copper alloy, stainless steel, steel, a carbon-based conductive material, a conductive polymer, a conductive elastomer, a conductive fluorocarbon material, and combinations thereof.

16. The electrical cord pet-biting deterrent system of claim 12, wherein the voltage is in a voltage range of between 3.0 V and 50 V.

17. The electrical cord pet-biting deterrent system of claim 12, wherein the current is in a current range of between 1.0 mA and 35 mA.

18. The electrical cord pet-biting deterrent system of claim 13, wherein the length of time is in a range of between 0.001 seconds and 10 seconds.
